(19) United States
(12) Patent Application Publication
(10) Pub. No.: US 2025/0216816 A1
(43) Pub. Date: Jul. 3, 2025

(54) RECHARGEABLE SMARTWATCH STRAP AND WATCH

(71) Applicant: WEI WU, Shenzhen (CN)

(72) Inventor: WEI WU, Shenzhen (CN)

(21) Appl. No.: 18/981,361

(22) Filed: Dec. 13, 2024

(30) Foreign Application Priority Data
Dec. 29, 2023 (CN) 2023236461325
Nov. 27, 2024 (CN) 2024229067422

(51) Int. Cl. G04C 10/00; A44C 5/00; H02J 7/00; H02J 50/00; H02J 50/10; H02J 50/90

(52) U.S. Cl. CPC G04C 10/00; A44C 5/0007; H02J 7/0063; H02J 50/005; H02J 50/90; H02J 50/10

(57) ABSTRACT

The present invention provides a rechargeable smartwatch strap, where the smartwatch strap includes a first strap body; the first strap body is provided with a charging coil, a charging port, a flexible circuit, and a control circuit; the flexible circuit is connected to the charging coil and the charging port; the control circuit controls an external power supply to charge the watch body; when the control circuit controls charging of the external power supply, the watch body is charged via the charging port, the flexible circuit, and the charging coil. In use procedure, the first strap body is rotated to the bottom portion of the watch body; the charging coil and the charge receiving coil on the watch body just form a loop to achieve charging via a built-in battery or a universal charging port, thereby avoiding the inconvenience caused by a dedicated charger and improving the charging convenience.

### CROSS-REFERENCE TO RELATED APPLICATIONS

The application claims priority to Chinese patent application No. 2024229067422, filed on Nov. 27, 2024 and Chinese patent application No. 2023236461325, filed on Dec. 29, 2023, the entire contents of which are incorporated herein by reference.

### TECHNICAL FIELD

The present invention relates to the technical field of smartwatches, and in particular to a rechargeable smartwatch strap, and a watch.

### BACKGROUND

Due to the limitations in the trend of lightweight development, waterproof, and other functions, the existing smartwatches generally cannot be charged with a standard data interface, resulting in the occurrence of various chargers for different smartwatches, which demands a dedicated charger to achieve charging. In the context of going out for a long time or using a watch for a long time, the watch is short of time of endurance and thus, needs to be charged in time. Therefore, users often have to carry a dedicated charger instead of sharing a universal charger, thus causing much inconvenience to users and a poor experience feeling of users.

### SUMMARY

The technical problem to be mainly solved in the present invention is to provide a rechargeable smartwatch strap, and a watch. The rechargeable smartwatch strap can achieve direct charging to smartwatches using a universal charger, thereby avoiding the inconvenience caused by a dedicated charger and improving the experience feeling of users.

To solve the aforesaid problem, the present invention provides a rechargeable smartwatch strap, including a first strap body connected to a watch body; the first strap body is provided with a charging coil, a charging port, a flexible circuit, and a control circuit; the flexible circuit is connected to the charging coil and the charging port; the control circuit controls an external power supply to charge the watch body via the charging port or a battery built in the first strap body; when the battery is built in the first strap body, the control circuit controls the battery to charge the watch body via the charging coil, or controls the external power supply to charge the battery via the charging port; and when the control circuit controls charging of the external power supply, the watch body is charged via the charging port and the charging coil.

In a preferred embodiment, the first strap body includes a connecting portion and a movable connecting mechanism located at one end of the connecting portion; the movable connecting mechanism is connected to the watch body; and the movable connecting mechanism is rotationally matched with the connecting portion during charging such that the charging coil moves to a charging position parallel to the watch body.

In a preferred embodiment, the movable connecting mechanism includes a metal seat connected to the connecting portion and a metal switching block; the metal seat is connected to the connecting portion; a notch is disposed in a connecting direction of the metal seat and is internally provided with two shaft holes; a first rotating shaft and a second rotating shaft are disposed at both ends of the metal switching block in the connecting direction, respectively, wherein two ends of the first rotating shaft are fixedly matched with the two shaft holes, respectively; and the second rotating shaft is rotationally matched with the watch body.

In a preferred embodiment, the notch is provided with a stopper for limiting an outward rotation angle of the metal switching block.

In a preferred embodiment, the connecting portion is provided with a fixed groove at the charging coil, and is provided with a magnetic component in attraction fixation with the watch body during charging, and the magnetic component is disposed in the fixed groove.

In a preferred embodiment, the smartwatch strap further includes a second strap body, and one end of the second strap body is movably connected to the watch body via the movable connecting mechanism.

In a preferred embodiment, the first strap body is provided with a rigid protective portion for protecting the charging port, and the rigid protective portion is provided with a slot or hole for holding the charging port.

In a preferred embodiment, the second strap body is provided with a magnet in attraction fixation with the rigid protective portion during charging.

In a preferred embodiment, a folding cavity enabling the first strap body to fold towards the charging position parallel to the watch body is disposed at one end of the first strap body close to the watch body along a length direction or a width direction; and a cross section of the folding cavity in a direction vertical to a length is prismatic.

In a preferred embodiment, a magnetically controlled switch controlling charging to the watch body is disposed between the first strap body and the second strap body, wherein the magnetically controlled switch is disposed on the first strap body, and the second strap body is provided with a magnet matched with the magnetically controlled switch; when the first strap body is located at the charging position of the watch body, the control circuit receives a signal of the magnetically controlled switch triggered by the magnet to control the charging coil to charge the watch body.

In a preferred embodiment, the flexible circuit includes a PFC circuit.

In a preferred embodiment, the first strap body and the second strap body include a silica gel; when the first strap body is provided with a battery, the first strap body is internally provided with a cavity for holding the battery and a cavity for holding the control circuit, respectively, and each of the cavities is disposed independently.

In a preferred embodiment, an annular fixing groove is disposed at one end of the metal seat matched with the connecting portion, and a guide slot or a through hole connected to the fixing groove is further disposed in the connecting direction.

In a preferred embodiment, a first folding groove is disposed at one end of the connecting portion close to the movable connecting mechanism; the first folding groove includes an outer folding groove and an inner folding groove, and where an opening angle of the outer folding groove is greater than an opening angle of the inner folding groove; and the connecting portion curves inwards at one end close to the movable connecting mechanism.

The present invention further provides a watch; the watch includes a watch body and a watch strap connected to a watch body; the watch strap includes a first strap body connected to the watch body; the first strap body is provided with a charging coil, a charging port, a flexible circuit, and a control circuit; the flexible circuit is connected to the charging coil and the charging port; the control circuit controls an external power supply to charge the watch body via the charging port or a battery built in the first strap body; when the battery is built in the first strap body, the control circuit controls the battery to charge the watch body via the charging coil, or controls the external power supply to charge the battery via the charging port; and when the control circuit controls charging of the external power supply, the watch body is charged via the charging port and the charging coil.

In a preferred embodiment, the first strap body includes a connecting portion and a movable connecting mechanism located at one end of the connecting portion; the movable connecting mechanism is connected to the watch body; and the movable connecting mechanism is rotationally matched with the connecting portion during charging such that the charging coil moves to a charging position parallel to the watch body.

In a preferred embodiment, the movable connecting mechanism includes a metal seat connected to the connecting portion and a metal switching block; the metal seat is connected to the connecting portion; a notch is disposed in a connecting direction of the metal seat and is internally provided with two shaft holes; a first rotating shaft and a second rotating shaft are disposed at both ends of the metal switching block in the connecting direction, respectively, where two ends of the first rotating shaft are fixedly matched with the two shaft holes, respectively; and the second rotating shaft is rotationally matched with the watch body.

In a preferred embodiment, the notch is provided with a stopper for limiting an outward rotation angle of the metal switching block.

In a preferred embodiment, the connecting portion is provided with a fixed groove at the charging coil, and is provided with a magnetic component in attraction fixation with the watch body during charging, and the magnetic component is disposed in the fixed groove.

In a preferred embodiment, the watch strap further includes a second strap body, and one end of the second strap body is movably connected to the watch body via the movable connecting mechanism.

In a preferred embodiment, the first strap body is provided with a rigid protective portion for protecting the charging port, and the rigid protective portion is provided with a slot or hole for holding the charging port.

In a preferred embodiment, the second strap body is provided with a magnet in attraction fixation with the rigid protective portion during charging.

In a preferred embodiment, a folding cavity enabling the first strap body to fold towards the charging position parallel to the watch body is disposed at one end of the first strap body close to the watch body along a length direction or a width direction; and a cross section of the folding cavity in a direction vertical to a length is prismatic.

In a preferred embodiment, a magnetically controlled switch controlling charging to the watch body is disposed between the first strap body and the second strap body, wherein the magnetically controlled switch is disposed on the first strap body, and the second strap body is provided with a magnet matched with the magnetically controlled switch; when the first strap body is located at the charging position of the watch body, the control circuit receives a signal of the magnetically controlled switch triggered by the magnet to control the charging coil to charge the watch body.

In a preferred embodiment, the flexible circuit includes a PFC circuit.

In a preferred embodiment, the first strap body and the second strap body include a silica gel; when the first strap body is provided with a battery, the first strap body is internally provided with a cavity for holding the battery and a cavity for holding the control circuit, respectively, and each of the cavities is disposed independently.

In a preferred embodiment, an annular fixing groove is disposed at one end of the metal seat matched with the connecting portion, and a guide slot or a through hole connected to the fixing groove is further disposed in the connecting direction.

In a preferred embodiment, a first folding groove is disposed at one end of the connecting portion close to the movable connecting mechanism; the first folding groove includes an outer folding groove and an inner folding groove, and where an opening angle of the outer folding groove is greater than an opening angle of the inner folding groove; and the connecting portion curves inwards at one end close to the movable connecting mechanism.

The present invention provides a rechargeable smartwatch strap and a watch, where the smartwatch strap includes a first strap body connected to the watch body; the first strap body is provided with a charging coil, a charging port, a flexible circuit, and a control circuit; the flexible circuit is connected to the charging coil and the charging port; the control circuit controls an external power supply or a battery built in the first strap body to charge the watch body; when the battery is built in the first strap body, the control circuit controls the battery to charge the watch body via the flexible circuit and the charging coil, or controls the external power supply to charge the battery via the charging port and the flexible circuit; and when the control circuit controls charging of the external power supply, the watch body is charged via the charging port, the flexible circuit, and the charging coil. In use procedure, the first strap body is rotated in parallel to the bottom portion of the watch body; the charging coil and the charge receiving coil on the watch body just form a loop to achieve charging via a built-in battery or a universal charging port, thereby avoiding the inconvenience caused by a dedicated charger and improving the charging convenience.

### BRIEF DESCRIPTION OF DRAWINGS

To specify the embodiments of the present invention or the technical solution in the prior art more clearly, the accompanying drawings required in the description of the embodiments or prior art will be introduced briefly. Obviously, the depicted accompanying drawings merely show some examples of the present invention and thus, shall be not construed as limiting the scope. Those skilled in the art can further obtain other correlated drawings according to these accompanying drawings without any inventive effort.

FIG. 1 is a schematic diagram showing a structure of a smartwatch embodiment;

FIG. 2 is a schematic diagram showing a structure of the smartwatch embodiment in a placement state;

FIG. 3 is a schematic diagram showing an electrical structure of the smartwatch embodiment;

FIG. 4 is a schematic diagram showing an open structure of a watch strap not charging to a smartwatch;

FIG. 5 is a schematic diagram showing a structure when the smartwatch is charged by the strap;

FIG. 6 is a schematic diagram showing a structure when the smartwatch is charged by another embodiment of the strap;

FIG. 7 is a schematic diagram showing a structure of a further embodiment of the smartwatch strap;

FIG. 8 is a schematic diagram showing a side-looking structure of a further embodiment of the smartwatch strap;

FIG. 9 is a schematic diagram showing a spatial structure of a further embodiment of the smartwatch strap;

FIG. 10 is a schematic diagram showing a structure of a movable connecting mechanism embodiment;

FIG. 11 is a schematic diagram showing a structure of the movable connecting mechanism from another view;

FIG. 12 is a schematic diagram showing a sectional structure of another embodiment of the movable connecting mechanism along a connecting direction;

FIG. 13 is a schematic diagram showing a structure when the smartwatch is charged by the strap; and

FIG. 14 is a schematic diagram showing a structure of another smartwatch embodiment.

The purpose realization, functional features, and advantages of the present invention will be further specified in combination with the embodiments and with reference to the accompanying drawings.

### DETAILED DESCRIPTION OF THE EMBODIMENTS

Claims of the present invention will be further specified in combination with the detailed embodiments and with reference to the accompanying drawings below. Obviously, the described embodiments are merely a portion of the embodiments, but not all the embodiments in the present invention. Based on the embodiments of the present invention, all the other embodiments obtained by those skilled in the art without any inventive effort shall fall within the scope of protection of the present invention.

It needs to be understood that the orientations or positional relations indicated by all the directionally indicative terms such as “upper”, “lower”, “left”, “right”, “front”, and “rear” described in the embodiments of the present invention are based on the orientations or positional relations as shown in the accompanying drawings, or the conventional placement orientations or positional relations of the product of the present invention. These are merely to simply the description of the present invention, but are not to explicitly indicate or hint that the indicated devices, elements or components must have a specific orientation and specific orientation configuration, and thus, are not construed as limiting the present invention. These are merely used to interpret the relative positional relation, movement situation and the like among components as shown in the accompanying drawings; when a specific posture changes, the directional indication also possibly changes therewith.

In addition, the ordinal numerals in the present invention, such as “first” and “second” are merely for the purpose of distinguishing, but are not construed as indicating or hinting its relative importance or implying the number of the technical features indicated. The “first” and “second” features defined thereby may explicitly indicate or hint at least one of the technical features. In the description of the present invention, “a plurality of” means at least two, i.e., two or more, unless otherwise stipulated explicitly; “at least one” means one or more.

In the present invention, terms such as “mount”, “dispose”, “connect”, “fix”, and “rotary connection” should be understood in broad sense, unless otherwise stipulated and defined explicitly. For example, it may be relative fixation among components in positional relation, the presence of physical fixed connection, detachable connection, or may be integrated into an integral structure; it may be mechanical connection, and also electrical signal connection; it may be direct connection, and also indirect connection via a medium or a component; it may be internal communication between two components, and also interactive relationship between two components, unless otherwise defined in the description explicitly, i.e., the corresponding function or effect may not be achieved when it is interpreted in other means. Those skilled in the art may understand the specific meanings of the aforesaid terms in the present invention according to specific circumstances.

Controllers and control circuits (if any) involved in the present invention are conventional control technologies or units to those skilled in the art; for example, the control circuit of a controller may be achieved by those skilled in the art via prior art, e.g., simple programming. As for the software or program in coordination with hardware to achieve control results, if it is not specified in the description to denote the involved software or program control procedure, it falls within the prior art or conventional technologies to those skilled in the art. Power supply is also subjected to the prior art in the art. Moreover, the major technical point of the present invention lies in the improvement of a mechanical device. Hence, the specific circuit control relationship and electrical connection will be not described in detail here.

The disclosure of the present invention provides lots of different embodiments or examples to achieve different structures of the present invention. To simply the disclosure of the present invention, components and configuration of specific examples are described in the present invention. Certainly, these are only examples and not aimed at limiting the present invention. In addition, the present invention may repeatedly reference numerals and/or letters in different examples; such a repetition is for the purpose of simplification and clarification, but is not indicative of the relationship among the discussed each embodiment and/or configuration. Additionally, the present invention provides various examples of specific processes and materials, but those skilled in the art may realize the application of other processes and/or use of other materials.

Preferred embodiments of the present invention will be specified with reference to the accompanying drawings. It should be understood that detailed embodiments described herein are merely used to specify and interpret the present invention, but are not construed as limiting the present invention.

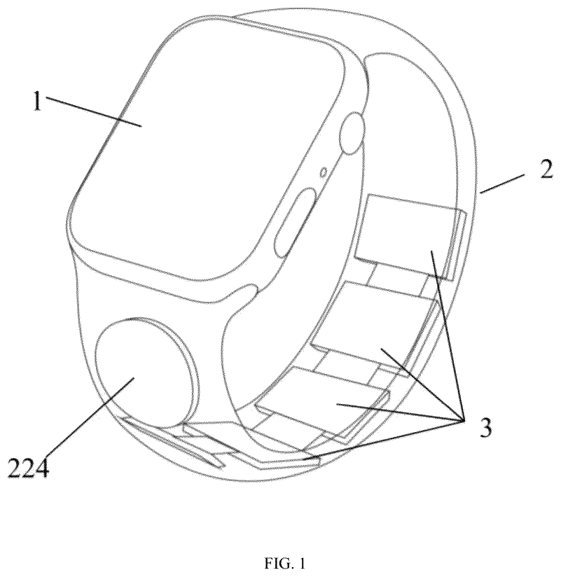

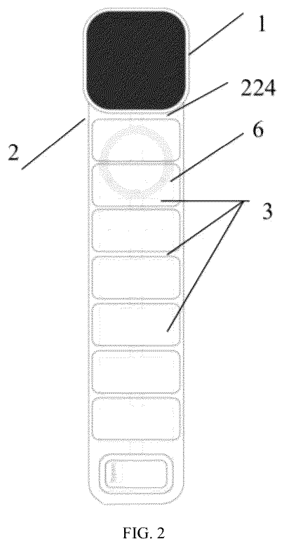

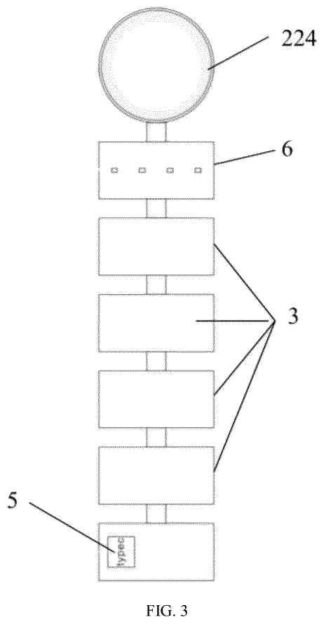

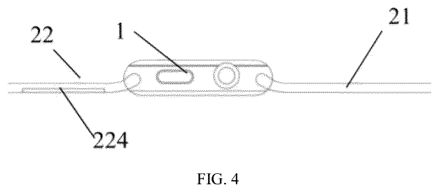

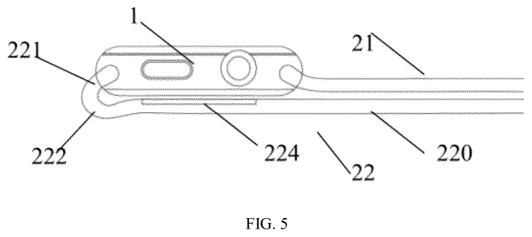

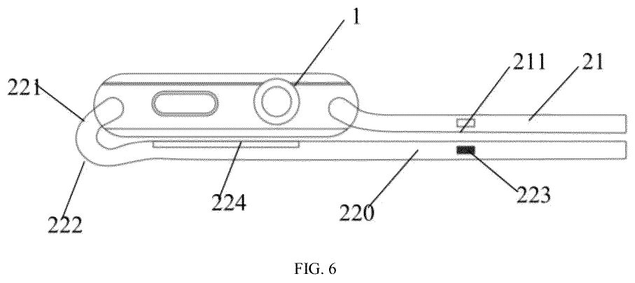

As shown in FIGS. 1-6, the present invention provides an embodiment of a smartwatch strap.

The smartwatch strap 2 includes a first strap body 22 and a second strap body 21 each having one end connected to a watch body 1, respectively; a connecting mechanism (not marked in the drawings) is disposed between another end of the first strap body 22 and another end of the second strap body 21. The first strap body 22 is provided with a flexible circuit, a charging coil 224, a charging port 5, and a control circuit 6 in electrical connection with the charging coil 224. During control process, after the first strap body 22 is folded, the charging coil 224 and a charge receiving coil (not marked in the drawings) on the watch body 1 form a wireless charging circuit. The control circuit 6 controls the charging port 5 to be connected with an external power supply, thus charging the watch body 1 via the charging coil 224. The first strap body 22 may be provided with a battery 3; when the battery is built in the first strap body 22, the control circuit 6 controls the battery 3 to charge the watch body 1 via the flexible circuit and the charging coil 224; alternatively, the control circuit 6 controls the external power supply to charge the battery 3 via the charging port 5 and the flexible circuit; and when the control circuit 6 controls charging of the external power supply, the watch body 1 is charged via the charging port 5, the flexible circuit, and the charging coil 224.

Specifically, when the battery 3 is provided, the battery 3, flexible circuit, charging coil 224, charging port 5, and control circuit 6 may be disposed in the first strap body 22; and the charging port 5 is disposed at one end portion of the first strap body 22. The battery 3 is in a distributed mode, i.e., a plurality of battery blocks are connected in series and/or in parallel. When the first strap body 22 is not provided with the battery 3, the charging port 5, battery 3, flexible circuit, charging coil 224, and the control circuit 6 may be disposed in the first strap body 22, and also may be internally disposed in the second strap body 21 according to the requirements. It is illustrated in this embodiment by disposing in the first strap body 22 as an example. The charging port 5 may be a universal interface, e.g., TYPE-C and other interfaces. When the first strap body 22 is provided with the battery 3, the first strap body 22 is provided with cavities (not marked in the drawings) for holding the battery 3, the control circuit 6, and the charging coil 224; and each of the cavities is disposed independently. The first strap body 22 and the second strap body 21 may be elastic materials inclusive of a silica gel material. The battery 3 is connected to the control circuit 6 and charging coil 224 via a flexible circuit to achieve electrical signal communication; the flexible circuit includes FPC. The control circuit 6 is provided with an indicator lamp displaying battery level.

The first strap body 22 includes a first connecting portion 221, a second connecting portion 220, and a bending portion 222, where the first connecting portion 221 is connected to the watch body 1; the bending portion 222 is connected to the first connecting portion 221 and the second connecting portion 220. The bending portion 222 will bend greatly while charging the watch body 1 via the strap; when the first connecting portion 221 and the watch body 1 are absence of rotation, the bending portion 222 has a bending angle of not lower than 90 from the usage status to the charging status. Bendability of the bending portion 222 is at least not lower than the bendability of the first connecting portion 221 and the second connecting portion 220. If the bending portion 222, the first connecting portion 221 and the second connecting portion 220 are made of a same material, the bendability of the three are basically the same in case of equal thickness and width.

Bendability of the bending portion 222 is higher than that of the first connecting portion 221 and the second connecting portion 220 for the convenience of bending such that the charging coil 224 and the charge receiving coil of the watch body 1 form a better charging contact status more easily. Preferably, the bendability of the bending portion 222 is greater than that of the first connecting portion 221, and the bendability of the first connecting portion 221 is greater than that of the second connecting portion 220. Bendability refers to the deformation size of the bending portion. The bending portion 222 is internally provided with a plurality of folding cavities (not marked in the drawings) disposed along a length direction of the first strap body 22; a cross section of the folding cavity along a direction vertical to length is prismatic, thus making deformation easier during bending. According to the requirements, the bending portion 222 is also internally provided with a plurality of folding cavities (not marked in the drawings) which are disposed along a width direction of the first strap body 22 and enable the first strap body 22 to be folded in parallel to the watch body 1; a cross section of the folding cavity along a direction vertical to length is prismatic, thus making deformation easier during bending.

A magnetically controlled switch 223 connected to the control circuit 6 via a signal is disposed between the first strap body 22 and the second strap body 21, where the magnetically controlled switch 223 is disposed on the first strap body 222, and the second strap body 21 is provided with a magnet 211 matched with the magnetically controlled switch 223; when the first strap body 220 is located at the charging position of the watch body 1, the control circuit 6 receives a signal of the magnetically controlled switch 223 triggered by the magnet 211 to control the charging coil 224 to charge the watch body 1. The magnetically controlled switch 223 is matched with the magnet 211 to achieve the charging automatic control after bending.

A first magnetic assembly (not marked in the drawings) for correcting and fixing the charging position is disposed between the charge receiving coil on the watch body 1 and the charging coil 224 on the first strap body 22, so as to ensure that the charge receiving coil on the watch body 1 and the charging coil 224 on the first strap body 22 may be located at the optimal charging position. The first magnetic assembly includes an annular magnetic component disposed on the watch body 1 and a first magnetic component (not marked in the drawings) disposed on the first strap body 22. The first magnetic component is located around the charging coil, and inclusive of inner and outer parts, is connected to the annular magnetic component during charging via a magnetic force.

To ensure the stability of connection during charging, a second magnetic assembly (not marked in the drawings) is disposed between the first strap body 22 and the second strap body 21; when the watch body 1 is charged by the first strap body 22, the two magnetic assemblies form attraction fixation.

When the watch body 1 needs to be charged, the first strap body 22 is bended; that is, the bending portion 222 is bended such that the charging coil 224 on the second connecting portion 220 is in parallel contact with the charge receiving coil on the watch body 1. Moreover, positions of the charging coil 224 and the charge receiving coil are corrected and fixed via the magnetic assemblies. When the magnetically controlled switch 223 on the first strap body 22 contacts the magnet 211 on the second strap body 21, the magnetically controlled switch 223 is triggered; at this time, the control circuit 6 controls the charging coil 205 to charge the watch body 1, thereby supplementing electric quantity for the watch body 1 in time. Electric quantity is supplemented via a universal USB cable or the watch body is charged with a built-in battery given that there is no need for users to carry a dedicated charger, which is thus convenient for use and improves experience feeling of the users. The control circuit 6 is provided with an indicator lamp displaying battery level of the battery 3 to know about the battery level in the strap in time.

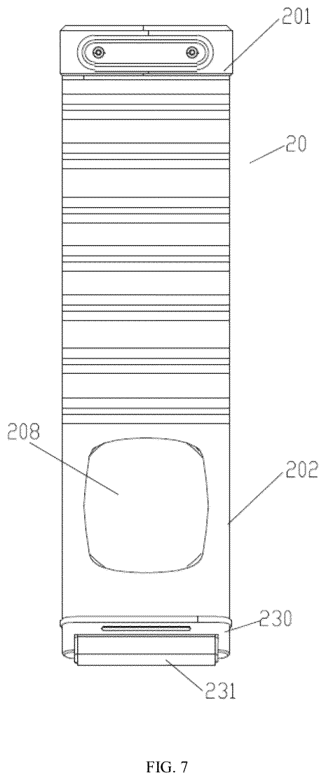

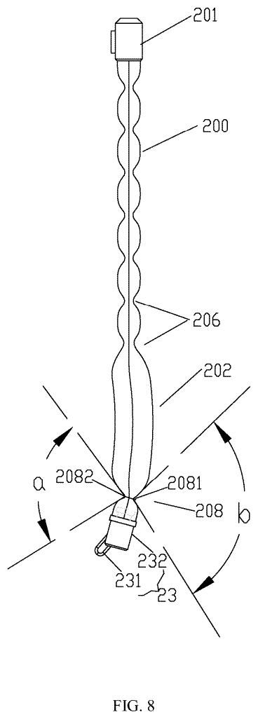

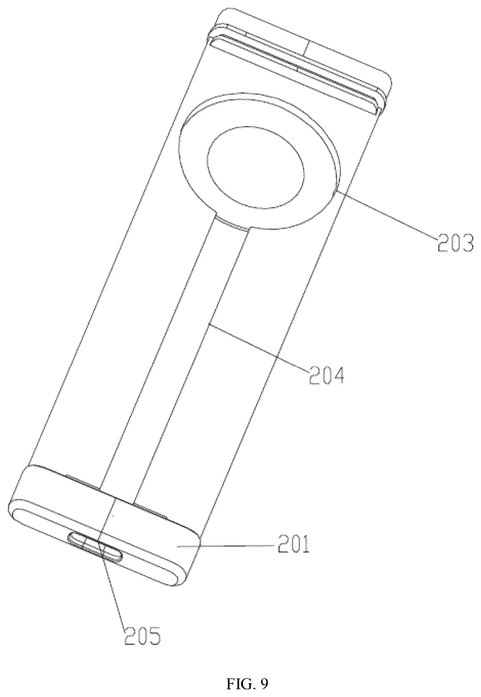

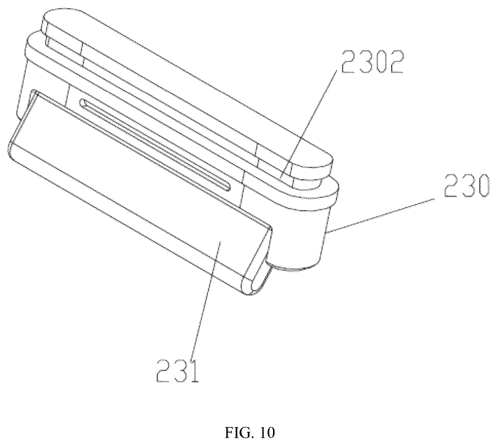

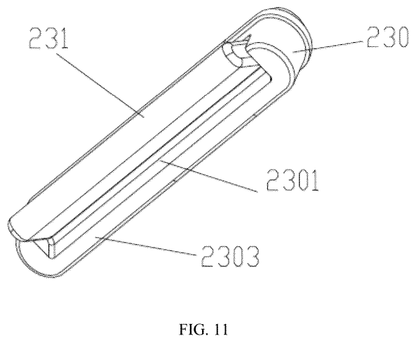

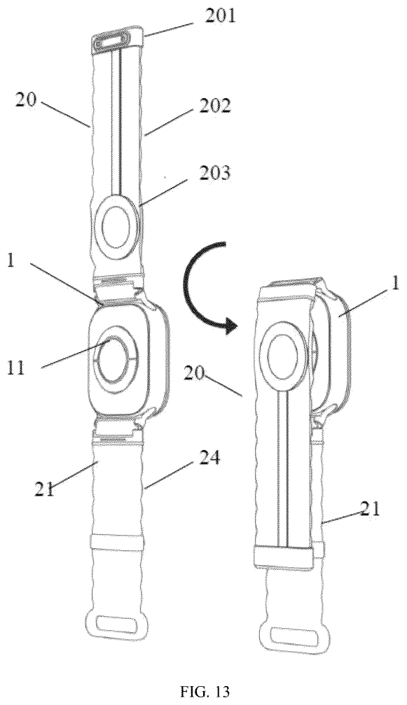

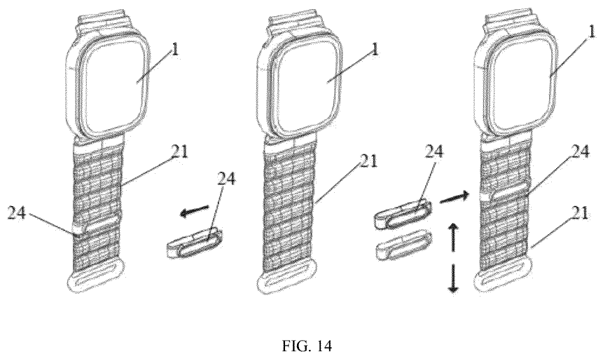

As shown in FIGS. 7-14, the present invention provides another embodiment of the smartwatch strap.

The rechargeable smartwatch strap includes a first strap body 20 connected to a watch body 1; the first strap body 20 is provided with a charging coil 203, a charging port 205, a flexible circuit 204, and a control circuit (not marked in the drawings); the flexible circuit 204 is connected to the charging coil 203 and the charging port 205. When the charging coil 203 is located at the charging position of the watch body 1, the external power supply of the charging port 205, the flexible circuit 204, and the charging coil 203 form an electric connection to charge the watch body 1. When the battery is built in the first strap body 20, the watch body I may be charged directly by the battery; the battery built in the first strap body 20 may be also charged when the charging port 205 is connected to the external power supply. The charging port 205 may be a universal interface, e.g., TYPE-C and other universal interfaces.

Specifically, the first strap body 20 includes a connecting portion 202, a connecting end, and a free end, where the charging port 205 is disposed at the free end, and the connecting end is provided with a movable connecting mechanism 23; that is, the first strap body 20 includes a connecting portion 202 and the movable connecting mechanism 23 located at the free end of the connecting portion 202. The movable connecting mechanism 23 is connected to the watch body 1; the charging coil 203 is disposed on the connecting portion 202; the movable connecting mechanism 23 is rotationally matched with the connecting portion during charging such that the charging coil 203 may rotate to the charging position of the watch body 1.

The movable connecting mechanism 23 includes a metal seat connected to the connecting portion and a metal switching block; the metal seat is connected to the connecting portion; a notch is disposed in a connecting direction of the metal seat; a first rotating shaft and a second rotating shaft are disposed at both ends of the metal switching block in the connecting direction, respectively, where two ends of the first rotating shaft are fixedly matched with the two shaft holes disposed in the notch, and the second rotating shaft is directly or indirectly rotationally matched with the watch body 1. Specifically, the movable connecting mechanism 23 includes a metal seat 230 connected to the connecting portion 202 and a metal switching block 231; a notch 2301 is disposed in a connecting direction of the metal seat 230; a first rotating shaft (not marked in the drawings) and a second rotating shaft (not marked in the drawings) are disposed at both ends of the metal switching block 231 in the connecting direction, respectively, where two ends of the first rotating shaft are fixedly matched with the two shaft holes (not marked in the drawings) disposed in the notch 2301, and the second rotating shaft (not marked in the drawings) is directly or indirectly rotationally matched with the watch body 1.

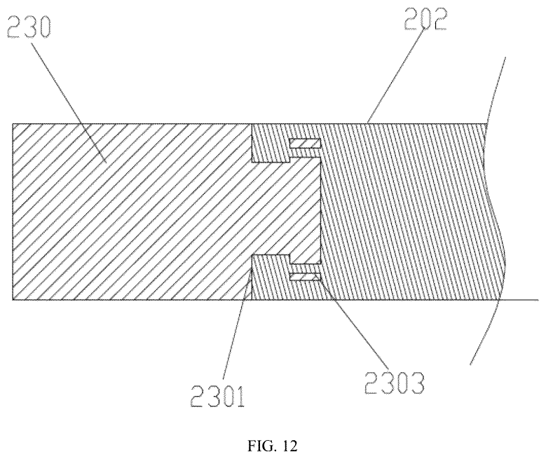

To improve the connection stability and reliability of different materials, an annular fixing groove 2302 is disposed at each connecting end of the metal seat 2230 and the connecting portion 202. When the connecting portion 202 is made of a silica gel, and other materials, the connecting portion is connected to the metal seat 230 via injection molding. According to the requirements, a guide slot or a through hole 2304 may be further disposed in the connecting direction of the fixing groove 2302, thus further enhancing connection strength, as shown in FIG. 12. According to the requirements, the notch 2301 is provided with a stopper 2303 for limiting an outward rotation angle of the metal switching block 231.

To decrease the displacement existing in charging to improve the charging efficiency better, the connecting portion 202 is provided with a fixed groove 207 at the charging coil 203, and is provided with a magnetic component (not marked in the drawings) in attraction fixation with the watch body 1 during charging, and the magnetic component is disposed in the fixed groove 207, thus achieving positioning and fixation via the attraction of the magnetic component with the watch body 1 during charging. The magnetic component includes a permanent magnet, e.g., a magnet, and the like.

To enhance the flexibility of the connecting portion 202, the connecting portion 202 is provided with a plurality of second folding grooves 206, and adjacent folding grooves 206 form a bar-type bulge (not marked in the drawings). A first folding groove 208 is disposed at one end of the connecting portion 202 close to the movable connecting mechanism 23; the first folding groove 208 includes an outer folding groove 2081 and an inner folding groove 2082, and where an opening of the outer folding groove 2081 is greater than an opening of the inner folding groove 2082; that is, an opening angle b of the outer folding groove 2081 is greater than an opening angle a of the inner folding groove 2082 such that the connecting portion 202 curves inwards at one end close to the movable connecting mechanism 23. The first folding groove 208 may avoid the loose connection between the connecting portion 202 and the movable connecting mechanism 23 during charging, thereby enhancing the connecting reliability.

During charging, an electric connection is formed via the charging port 205, flexible circuit 204, and the charging coil 203. Under the coordination of the movable connecting mechanism 23, the watch strap is rotated, and at this time, the charging coil thereon is just located at the charging position of the watch body 1 to form a charging circuit, thereby achieving watch charging.

According to the requirements, the smartwatch strap further includes a second strap body 21, and one end of the second strap body 21 is movably connected to the watch body via the movable connecting mechanism 23. The first strap body 20 is provided with a rigid protective portion 201 for protecting the charging port 25, and the rigid protective portion 201 is provided with a slot or hole for holding the charging port.

According to the requirements, the second strap body 21 is provided with a magnet 24 in attraction fixation with the rigid protective portion 201 during charging, thus achieving multi-point fixation during charging such that the charging coil 203 is matched with the charging coil 11 on the watch body 1 more stably. The magnet 24 may be sleeved on the second strap body 21, and its position is adjusted according to the requirements to adapt for the different sizes of wrists.

As shown in FIGS. 1-13, the present invention further provides an embodiment of a smartwatch.

The smartwatch includes a watch body and a smartwatch strap connected to the watch body; the smartwatch strap adopts the watch strap of the above embodiment. The structure and operating principle are the same as those in the above embodiment and thus, will be not described anymore.

The above embodiments are merely for illustrative of the technical solution of the present invention, but are not construed as limiting the present invention. Even though the present invention is described in detail with reference to the preceding embodiments, those skilled in the art should understand as follows: the technical solution recited in the preceding embodiments may be still amended, or partial structures (technical features) in one or more embodiments are equivalently replaced and combined. Moreover, those amendments, replacements, and combinations will not enable the essence of the corresponding technical solution to depart from the spirit and scope of the technical solution in each embodiment, unless the embodiments explicitly exclude the possibility of replacing or combining the structures (technical features) in different embodiments, or such a replacement or combination is inconsistent with the overall concept of the present invention.

What is claimed is:

1. A rechargeable smartwatch strap, comprising a first strap body connected to a watch body, wherein the first strap body is provided with a charging coil, a charging port, a flexible circuit, and a control circuit; the flexible circuit is connected to the charging coil and the charging port; the control circuit controls an external power supply to charge the watch body via the charging port or a battery built in the first strap body; when the battery is built in the first strap body, the control circuit controls the battery to charge the watch body via the charging coil, or controls the external power supply to charge the battery via the charging port; and when the control circuit controls charging of the external power supply, the watch body is charged via the charging port and the charging coil.

2. The rechargeable smartwatch strap according to claim 1, wherein the first strap body comprises a connecting portion and a movable connecting mechanism located at one end of the connecting portion; the movable connecting mechanism is connected to the watch body; and the movable connecting mechanism is rotationally matched with the connecting portion during charging such that the charging coil moves to a charging position parallel to the watch body.

3. The rechargeable smartwatch strap according to claim 2, wherein the movable connecting mechanism comprises a metal seat connected to the connecting portion and a metal switching block; the metal seat is connected to the connecting portion; a notch is disposed in a connecting direction of the metal seat and is internally provided with two shaft holes; a first rotating shaft and a second rotating shaft are disposed at both ends of the metal switching block in the connecting direction, respectively, wherein two ends of the first rotating shaft are fixedly matched with the two shaft holes, and the second rotating shaft is rotationally matched with the watch body.

4. The rechargeable smartwatch strap according to claim 3, wherein the notch is provided with a stopper for limiting an outward rotation angle of the metal switching block.

5. The rechargeable smartwatch strap according to claim 3, wherein an annular fixing groove is disposed at one end of the metal seat matched with the connecting portion, and a guide slot or a through hole connected to the fixing groove is further disposed in the connecting direction.

6. The rechargeable smartwatch strap according to claim 2, wherein the connecting portion is provided with a fixed groove at the charging coil, and is provided with a magnetic component in attraction fixation with the watch body during charging, and the magnetic component is disposed in the fixed groove.

7. The rechargeable smartwatch strap according to claim 3, wherein the smartwatch strap further comprises a second strap body, and one end of the second strap body is movably connected to the watch body via the movable connecting mechanism.

8. The rechargeable smartwatch strap according to claim 1, wherein the first strap body is provided with a rigid protective portion for protecting the charging port, and the rigid protective portion is provided with a slot or hole for holding the charging port.

9. The rechargeable smartwatch strap according to claim 8, wherein the second strap body is provided with a magnet in attraction fixation with the rigid protective portion during charging.

10. The rechargeable smartwatch strap according to claim 1, wherein a folding cavity enabling the first strap body to fold towards the charging position parallel to the watch body is disposed at one end of the first strap body close to the watch body along a length direction or a width direction; and a cross section of the folding cavity in a direction vertical to a length is prismatic.

11. The rechargeable smartwatch strap according to claim 7, wherein a magnetically controlled switch controlling charging to the watch body is disposed between the first strap body and the second strap body, wherein the magnetically controlled switch is disposed on the first strap body, and the second strap body is provided with a magnet matched with the magnetically controlled switch; when the first strap body is located at the charging position of the watch body, the the control circuit receives a signal of the magnetically controlled switch triggered by the magnet to control the charging coil to charge the watch body.

12. The rechargeable smartwatch strap according to claim 2, wherein a first folding groove is disposed at one end of the connecting portion close to the movable connecting mechanism; the first folding groove comprises an outer folding groove and an inner folding groove, and wherein an opening angle of the outer folding groove is greater than an opening angle of the inner folding groove; and the connecting portion curves inwards at one end close to the movable connecting mechanism.

13. A watch, comprising a watch body and a watch strap connected to the watch body, and the watch strap comprising a strap body, wherein the strap body is the strap body of claim 1.

14. The watch according to claim 13, wherein the first strap body comprises a connecting portion and a movable connecting mechanism located at one end of the connecting portion; the movable connecting mechanism is connected to the watch body; and the movable connecting mechanism is rotationally matched with the connecting portion during charging such that the charging coil moves to a charging position parallel to the watch body.

15. The watch according to claim 14, wherein the movable connecting mechanism comprises a metal seat connected to the connecting portion and a metal switching block; the metal seat is connected to the connecting portion; a notch is disposed in a connecting direction of the metal seat and is internally provided with two shaft holes; a first rotating shaft and a second rotating shaft are disposed at both ends of the metal switching block in the connecting direction, respectively, wherein two ends of the first rotating shaft are fixedly matched with the two shaft holes, and the second rotating shaft is rotationally matched with the watch body, wherein the notch is provided with a stopper for limiting an outward rotation angle of the metal switching block.

16. The watch according to claim 15, wherein an annular fixing groove is disposed at one end of the metal seat matched with the connecting portion, and a guide slot or a through hole connected to the fixing groove is further disposed in the connecting direction.

17. The watch according to claim 14, wherein the connecting portion is provided with a fixed groove at the charging coil, and is provided with a magnetic component in attraction fixation with the watch body during charging, and the magnetic component is disposed in the fixed groove.

18. The watch according to claim 13, wherein a folding cavity enabling the first strap body to fold towards the charging position parallel to the watch body is disposed at one end of the first strap body close to the watch body along a length direction or a width direction; and a cross section of the folding cavity in a direction vertical to a length is prismatic.

19. The watch according to claim 13, wherein a first folding groove is disposed at one end of the connecting portion close to the movable connecting mechanism; the first folding groove comprises an outer folding groove and an inner folding groove, and wherein an opening angle of the outer folding groove is greater than an opening angle of the inner folding groove; and the connecting portion curves inwards at one end close to the movable connecting mechanism.
